(19) United States
(12) Patent Application Publication
(10) Pub. No.: US 2026/0152246 A1
(43) Pub. Date: Jun. 4, 2026

(54) A POWERED RETRACTION SYSTEM FOR A WHEEL

(71) Applicant: Howard Wright Limited, New Plymouth (NZ)

(72) Inventors: Angus Donald Ross McLeod, New Plymouth (NZ); Anthony John Batley, New Plymouth (NZ)

(21) Appl. No.: 19/122,971

(22) PCT Filed: Sep. 21, 2023
(86) PCT No.: PCT/IB2023/059326

§ 371 Date: Apr. 21, 2025

(30) Foreign Application Priority Data
Sep. 21, 2022 (AU) 2022902728

(51) Int. Cl. B62D 61/12; B60B 33/06

(52) U.S. Cl. CPC B62D 61/12; B60B 33/066

(57) ABSTRACT

The invention provides a powered retraction system for a wheel. The retraction system includes an actuation system to raise the wheel to a stowed position and to lower the wheel to a steer position. The actuation system includes: a motor that is operably connected to a rotatable torsion controller to rotationally drive the torsion controller about a torsion controller axis; a torsion element comprising opposing first and second ends; and a swing arm operably connected to the wheel axle and rotatable by the torsion controller about a swing arm axis to raise and lower the wheel. The first end of the torsion element engages with the rotatable torsion controller and the second end of the torsion element engages with the swing arm. When in the steer position, the torsion element is tensioned to urge the spring arm, and in turn the wheel, downwards.

### FIELD OF INVENTION

This invention relates to a powered retraction system to raise and lower a wheel for a wheeled apparatus, such as a hospital bed or a nursing care bed, a stretcher, trolley, or any other apparatus comprising a retractable wheel.

### BACKGROUND

It is common for a wheeled apparatus to comprise a chassis mounted on castors. The castors may be controlled electrically or manually in order to steer the wheeled apparatus. However, it is sometimes helpful for the chassis to also include a powered drive wheel to help steer the wheeled apparatus. This is particularly helpful for hospital beds, nursing care beds, stretchers, trolleys, and the like, where the wheeled apparatus has a long wheelbase and where it may bear a heavy load. Alternatively, the wheeled apparatus may include a non-powered auxiliary wheel. Such non-powered auxiliary wheels are typically substantially centrally located on a chassis of a wheeled apparatus, such as a hospital bed or stretcher and, in such cases, may offer the apparatus with a 5^{th} supplementary wheel to help steer the apparatus in addition to four castors located at or near four corners of the apparatus.

Retractable auxiliary wheels may be moveable between a steer position/drive position and a stowed position. In the steer position/drive position, a retractable auxiliary wheel is lowered to contact the ground surface/floor and to assist with steering the wheeled apparatus. However, in some instances it is preferred to raise the steer wheel off the ground to the stowed position. For example, where the wheeled apparatus is a stretcher, the wheel may be raised to the stowed position to help maneuver the stretcher in any direction (such as to move the stretcher sideways). By stowing the auxiliary wheel, fine positional adjustments of the wheeled apparatus are easier, such as moving the stretcher to align with a theatre operating table prior to transferring the patient from one to the other. Stowing the auxiliary wheel may also ensure that the wheel is out of the way of any equipment that may be slid beneath the chassis of the wheeled apparatus. For example, items such as patient hoists, patient standing aids and overbed tables all have legs with wheels that extend beneath the bed when being used.

However, it is important that powered and non-powered steer/drive wheels for hospital beds, care beds, stretchers, and trolleys in the medical field have a suspension system that allows the wheel to retain substantially constant contact with the ground surface, even if the ground surface is uneven.

It is also important for powered and non-powered steer/drive wheels and the retraction system for such wheels to be as vertically compact as possible. By providing a compact arrangement, the upper deck of the wheeled apparatus, such as a patient transport apparatus (for example, a stretcher or hospital bed), can be lowered to a lower low height without interfering with the steer/drive wheel. Having a lower low height is an advantage as it helps short patients get on and off the wheeled apparatus more safely.

It would therefore be advantageous to provide a retraction system for a drive/auxiliary wheel that goes at least some way towards meeting these needs and overcoming the disadvantages of the prior art, or that at least provides the public with a useful alternative.

### SUMMARY OF INVENTION

In a first aspect, the invention provides a powered retraction system for a wheel rotatable about a wheel axle, the retraction system comprising an actuation system to raise the wheel to a stowed position and to lower the wheel to a steer position. The actuation system comprises: a rotational drive element rotatable in a first direction and a second direction by the motor; a rotatable torsion controller rotatable about a torsion controller axis; a link rotatably connected to the rotational drive element and to the torsion controller to transfer rotational movement of the drive element to the torsion controller; a torsion element comprising opposing first and second ends and comprising a major axis extending substantially parallel to the wheel axle, the torsion element being held under tension; and a swing arm rotatable about a swing arm axis by the torsion controller, wherein the swing arm is operably connected to the wheel axle, distanced from the swing arm axis, such that rotating the swing arm about its rotational axis raises or lowers the wheel. The first end of the torsion element is fixedly engaged with the rotatable torsion controller and the second end of the torsion element is fixedly engaged with the swing arm. Rotation of the torsion controller in a first direction rotates the first end of the torsion element and increases torsion applied by the torsion element to the swing arm to urge the swing arm, and in turn the wheel, downwards; and rotation of the torsion controller in a second direction rotates the first end of the torsion element to decrease torsion applied by the torsion element to the swing arm and reduces downward pressure on the swing arm and therefore on the wheel.

In some forms, the torsion element is located within a torsion element housing that extends between first and second connecting members of the swing arm.

In some forms, the torsion element housing comprises a first end through which the first end torsion element extends to engage with the torsion controller, and a second end with which the second end of the torsion element is engaged.

In some forms, the torsion element is pre-tensioned before or during assembly of the retraction system, to urge the wheel toward the steer position.

Optionally, the torsion element comprises a pair of co-axial torsion springs.

The second end of each spring may be fixedly connected to the swing arm, either directly or indirectly.

In some forms, the link is rotatable about a first axis mounted off-centre on the rotational drive element and a second axis mounted off-centre on the torsion controller.

In some forms, the rotational drive element comprises a downward pressure member adapted to contact an upper surface of the link when the rotational drive element is rotated in a first direction and the link is over-centred in a first position, and an upward pressure member adapted to contact a lower surface of the link when the rotational drive element is rotated in an opposing second direction and the link is over-centred in a second position.

In some forms, the downward pressure member contacts the upper surface of the link when the wheel is in the steer position and the upward pressure member contacts the lower surface of the link when the wheel is in the stowed position.

In some forms, the link is over-centered in relation to the rotational axis of the rotational drive element when the wheel is in the steer position and also when the wheel is in the stowed position, so that the link and the downward and upward pressure members lock the wheel in the respective steer position and stowed position.

In some forms, the torsion controller comprises a pair of first and second limit stops, and the swing arm comprises a pair of first and second swing stops adapted to abut the limit stops to limit rotational movement of the swing arm when the wheel is in the steer position.

In some forms, the torsion controller and the swing arm are co-axially arranged and the limit stops, and the swing stops are radially spaced equidistant from the axis of rotation of the torsion controller and the swing arm.

In some forms, the torsion controller comprises a radially extending mounting tab that provides a mounting surface for the second rotational axis of the link. The link is preferably adapted to transfer rotational movement of the rotational drive element to rotational movement of the torsion controller.

In some forms, the mounting tab comprises substantially opposing side edges that form the first and second limit stops.

In some forms, the mounting tab is located between the swing stops and is rotatable between the swing stops as the torsion controller rotates.

In some forms, when the torsion controller is in a mid-steer position, a gap is formed between each of the limit stops and an adjacent one of each of the swing stops to allow rotational movement of the swing arm to provide a suspension system for the wheel.

In some forms, when the wheel is in a lower-most steer position, the first limit stop abuts the first swing stop to prevent further downward rotation of the swing arm.

In some forms, when the wheel is in an upper-most steer position, the second limit stop abuts the second swing stop to prevent further upward rotation of the swing arm.

In some forms, the retraction system further comprises a control system connected to a user interface adapted to receive user inputs corresponding to a position selection for the wheel, and at least one sensor to sense a current position of the wheel.

In some forms, the control system is operably connected to the motor and comprises a data processor adapted to receive data from the at least one sensor and process the data to determine the current position of the wheel.

Optionally, the control system operates the actuation system depending on the latest user input and the current position of the wheel as determined by the data processor.

In some forms, the retraction system comprises an optical encoder sensor and a toggle switch adapted to sense the direction, speed, and extent of rotation of the wheel, in addition to the current position of the wheel.

In a second aspect, the invention provides a wheeled apparatus comprising a retraction system of the first aspect of the invention.

In some forms, the wheeled apparatus is a patient transport apparatus, or a trolley.

In some forms, the apparatus comprises a powered drive wheel and the retraction system is operably connected to the drive wheel to raise the wheel to a stowed position and to lower the wheel to a steer position.

Unless the context clearly requires otherwise, throughout the description and the claims, the words “comprise”, “comprising”, and the like, are to be construed in an inclusive sense as opposed to an exclusive or exhaustive sense, that is to say, in the sense of “including, but not limited to”.

Reference to any prior art in this specification is not, and should not be taken as, an acknowledgement or any form of suggestion that that prior art forms part of the common general knowledge in the field of endeavour in any country in the world.

The invention consists in the foregoing and also envisages constructions of which the following gives examples only.

### BRIEF DESCRIPTION OF THE DRAWINGS

Preferred examples of the invention will now be described by way of example and with reference to the accompanying drawings, in which:

FIG. 1 is a schematic side view of one form of wheel retraction system of the invention and in which a wheel is shown in a lowered/steer position (a torsion element and a portion of the swing arm of the retraction system are not shown in order to illustrate the relationship between the pin, the torsion controller, and the swing arm);

FIG. 2 is a cross-sectional side view of one form of torsion element that may be used with the retraction system of the invention, the torsion element shown having two co-axial torsion springs;

FIG. 3 is a schematic side view of the retraction system of FIG. 1 from the other side, and in which the wheel is in the steer position;

FIG. 4 is a schematic side view of the retraction system of FIG. 1, from the other side and in which the wheel is raised in the stowed position;

FIG. 5 is a schematic side view of a retraction system of the invention, including a torsion element, and in which the wheel is in the steer position;

FIG. 6 is a schematic side view of the retraction system of FIG. 5, from the other side;

FIG. 7 is a schematic side view of a retraction system of the invention and in which the wheel is in the raised, stowed position (the torsion element and a portion of the swing arm of the retraction system is not shown in order to clearly illustrate the relationship between the pin, the torsion controller, and the swing arm);

FIG. 8 is a schematic side view of the retraction system of FIG. 7 and in which the torsion element and the spring arm are also shown and the wheel is in the raised, stowed position;

FIG. 9 is a schematic side view of the retraction system of FIG. 7 and in which the wheel is in the lowered, steer position;

FIG. 10 is a schematic side view of the retraction system of FIG. 9 and in which the torsion element and the spring arm are also shown and the wheel is in the lowered, steer position;

FIG. 11 is a schematic side view of the retraction system of FIG. 1 and illustrates how the rotational axes of the connecting link are generally aligned with the rotational axis of the rotational drive element before the upward pressure member of the rotational drive element presses against the connecting link to urge the link upward and lock the link in an over-centred first position, corresponding to the stowed position of the wheel;

FIG. 12 is a schematic side view of the retraction system of FIG. 11 and illustrates how the rotational axes of the connecting link are no longer aligned with the rotational axis of the rotational drive element when the connecting link is over-centred in the first position;

FIG. 13 is a schematic side view of the retraction system of FIG. 1 and illustrates how the rotational axes of the connecting link are generally aligned with the rotational axis of the rotational drive element before the downward pressure member of the rotational drive element presses against the connecting link to urge the link downward and lock the link in an over-centred second position, corresponding to the steer position of the wheel; and

FIG. 14 is a schematic side view of the retraction system of FIG. 13 and illustrates how the rotational axes of the connecting link are no longer aligned with the rotational axis of the rotational drive element when the connecting link is over-centred in the second position;

FIG. 15 is a schematic side view of the retraction system of FIG. 9 and in which the swing arm has rotated downward to allow the wheel to self-adjust its position relative to the chassis of the wheeled apparatus on which the retraction system is located, in order to accommodate a hollow area/depression in the ground surface, the wheel being in the lower-most steer position;

FIG. 16 is a schematic side view of the retraction system of FIG. 15 and in which the torsion element and spring arm are also shown, and the wheel is in the lower-most position;

FIG. 17 is a schematic side view of the retraction system of FIG. 9 and in which the swing arm has rotated upward to allow the wheel to self-adjust its position relative to the chassis of the wheeled apparatus on which the retraction system is located, in order to accommodate a bump/raised area in the ground surface, the wheel being in the upper-most steer position;

FIG. 18 is a schematic side view of the retraction system of FIG. 17 and in which the torsion element and spring arm are also shown, and the wheel is in the upper-most position;

FIG. 19 is a schematic side view of one form of wheel retraction system of the invention in which the wheel is passing over a bump;

FIG. 20 is an isometric view of another form of wheel retraction system of the invention and in which the wheel is in a mid-steer position;

FIG. 21 is a partial cutaway view of the retraction system of FIG. 20 in which the wheel is passing over a bump when in the steer position and the engagement element of the swing arm is engaged with an engagement feature located on the retraction system housing; and

FIG. 22 is an isometric view of one form of patient transport apparatus, in this case a stretcher, comprising a wheel retraction system of the invention.

### DETAILED DESCRIPTION OF PREFERRED EMBODIMENTS

The invention is further described with reference to the following examples. It will be appreciated that the invention as claimed is not intended to be limited in any way by these examples.

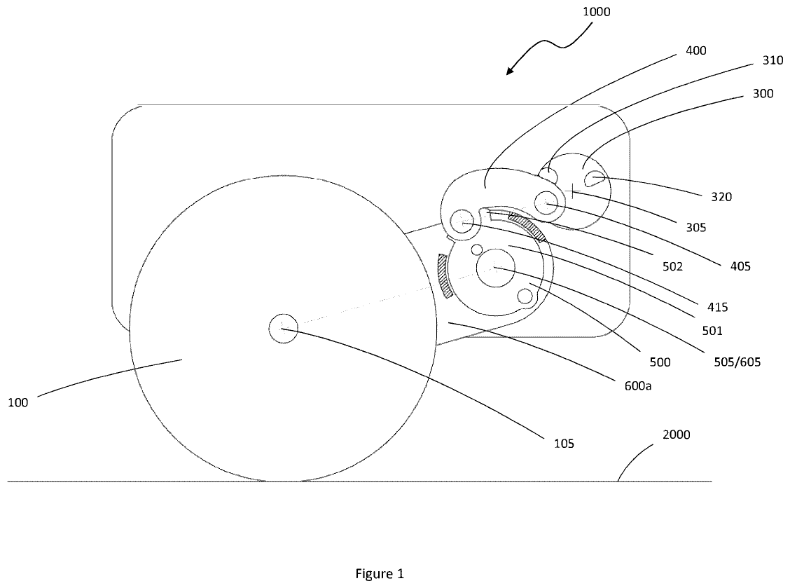

As exemplified in FIGS. 1 to 18, the present invention relates to a powered retraction system 1000 for a retractable wheel 100 for a wheeled apparatus 5000, such as a patient transport apparatus for example. The powered retraction system is particularly suited for retracting a powered auxiliary wheel, which is sometimes referred to as a drive wheel or a powered drive wheel, but may also be used for a non-powered auxiliary wheel.

For simplicity, the term ‘auxiliary wheel’ as used in relation to the invention disclosed and claimed herein, refers to both a powered auxiliary wheel (e.g., a powered drive wheel) and a non-powered auxiliary wheel used to assist steering of a wheeled apparatus. Typically, such auxiliary wheels are substantially centrally located on a chassis 4000 of the wheeled apparatus 5000, which may be a patient transport apparatus, such as a hospital bed, nursing care bed, or stretcher, and are supplementary to other wheels, such as castors located at or near corners of the wheeled apparatus.

The term ‘drive wheel’ as used in relation to the invention disclosed and claimed herein, refers to a powered drive wheel that is used to assist steering of a wheeled apparatus.

The retraction system 1000 is configured to attach the auxiliary wheel 100 to a chassis of a wheeled apparatus. The retraction system 1000 is adapted to lower the wheel 100 to contact a ground surface 2000 (such as a floor or the ground outside) to reach a down/drive/steer position, and to retract/raise the wheel off a ground surface 2000 to reach a raised/stowed position. The retraction system 1000 is configured to apply downward pressure to the wheel 100 in the steer position to urge the wheel to maintain constant contact with the ground surface 2000, even when the wheel passes over a bump or a hollow in the ground surface. In this way, the retraction system 1000 assists with the steerability of the wheeled apparatus and the smoothness at which the wheeled apparatus passes over the ground surface 2000. Of course, the unevenness of the ground surface should meet expected levels for the intended use of the wheeled apparatus. It is not expected that a wheeled apparatus consisting of a hospital stretcher bearing an auxiliary wheel controlled by a retraction system of the invention is to be rolled across a ground surface comprising a boulder bed, for example. The retraction system 1000 may comprise a suspension system that is configured so that the height of the wheel 100 relative to the chassis of the wheeled apparatus is automatically and freely adjustable (within limits) in the steer position, to accommodate bumps and depressions in the ground surface 2000. Such a retraction system 1000 therefore allows the wheel 100 to automatically raise or lower (to some extent), when passing over an uneven ground surface, such as when passing over a bump or a hollow.

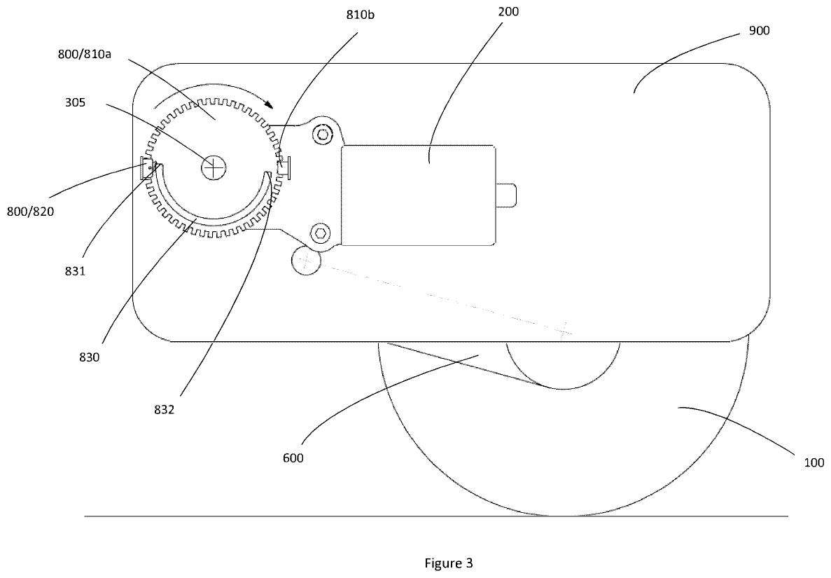

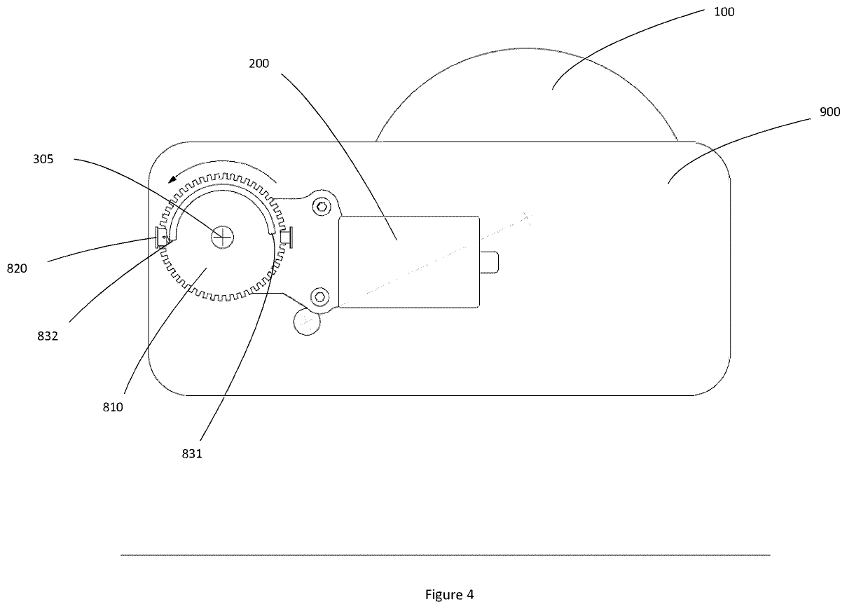

The retraction system 1000 of the invention comprises an actuation system to lower and raise an auxiliary wheel 100 of a wheeled apparatus between a steer position (as shown in FIG. 3) and a stowed position (as shown in FIG. 4) respectively. The actuation system comprises a motor 200, a torsion controller 500, a swing arm 600, and a torsion element 700. The motor is powered by a power source, such as a battery, and provides powered operation to the retraction system 1000. Preferably, the motor powers the retraction system electrically, but it is envisaged that the motor could otherwise power the retraction system hydraulically, as would be apparent to a person skilled in the art.

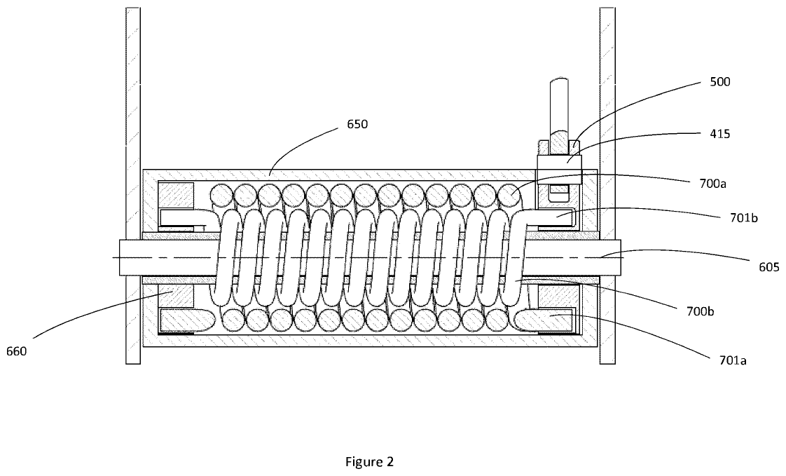

In some forms, as shown in FIGS. 1 and 2, the actuation system also comprises a rotational drive element/crank 300 and a link 400. The rotational drive element 300 is rotatable about a drive element/crank axis 305 and is driven in a clockwise direction or an anti-clockwise direction by the motor 200. In preferred forms, the rotational drive element 300 is directly connected to the motor, such that the rotational axis 305 of the drive element 300 is connected to the drive output of the motor 200.

The rotational drive element 300 comprises a first surface on which the link 400 is mounted. The link 400 is rotationally mounted on a first pivot pin comprising a first axis 405. The first axis 405 is located off-centre from the drive element axis 305 to form a crank arrangement.

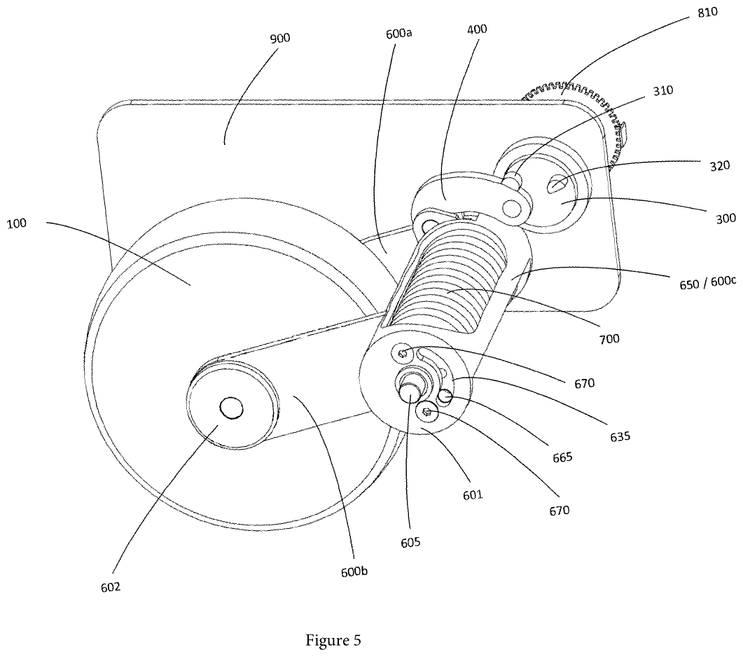

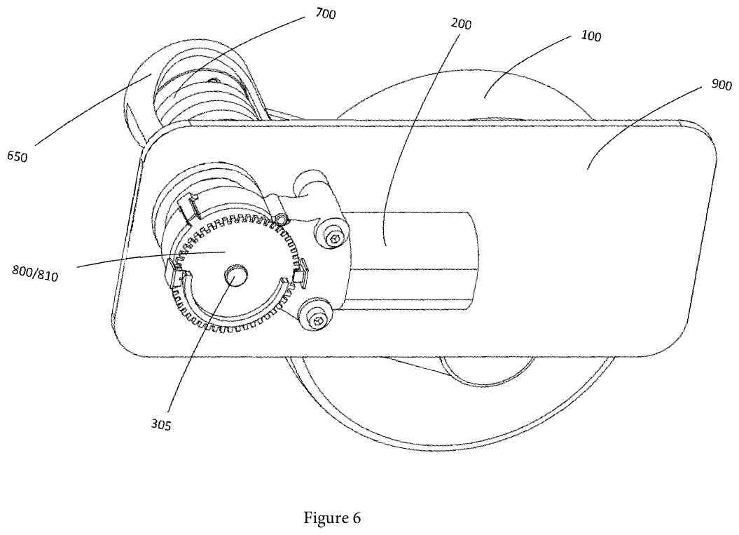

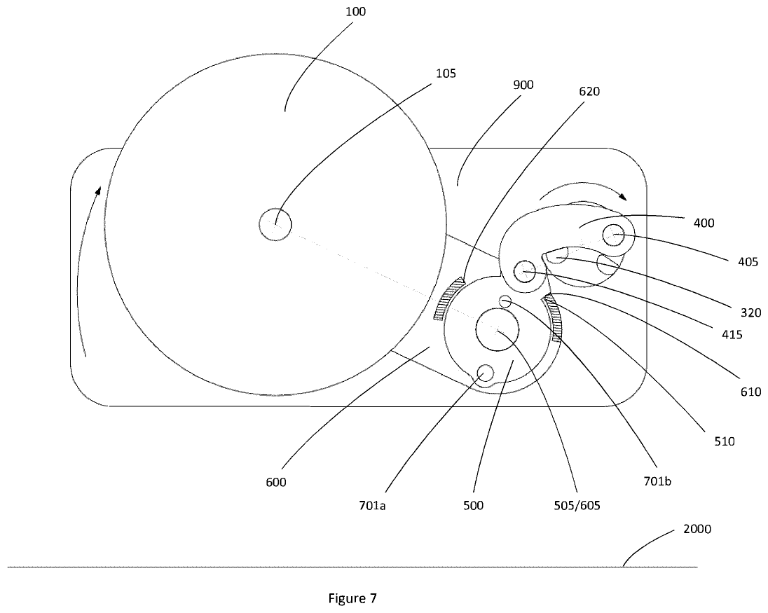

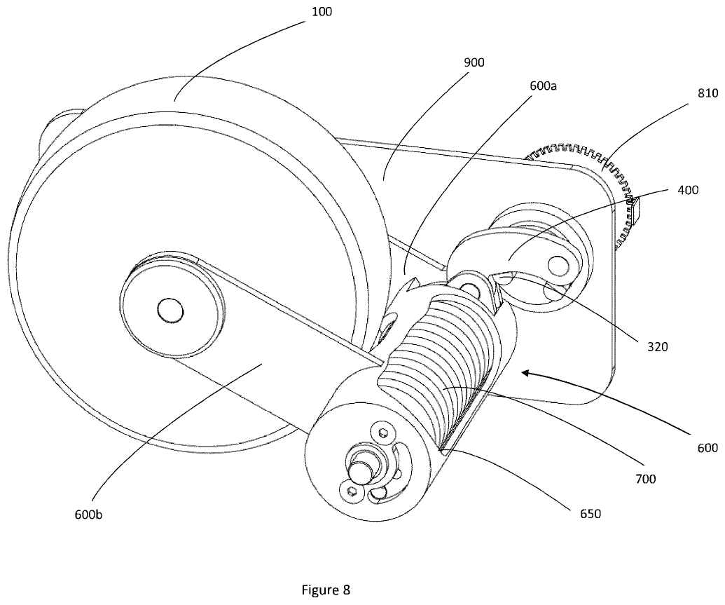

The rotational drive element 300 also comprises a pair of first and second projections 310, 320 that are configured to contact the link 400 and urge the link in a first direction and a second direction respectively. For example, the first projection may be considered to be a downward pressure member 310 that projects from the first surface of the rotational drive element 300 and that is configured to press against the link 400 in a downward direction when the wheel 100 is in the steer position, as shown in FIGS. 5 and 6. The second projection may be considered to be an upward pressure member 320 that projects from the first surface of the rotational drive element 300 and that is configured to press against the link 400 in an upward direction when the wheel 100 is in the stowed position, as shown in FIGS. 7 and 8. The first and second projections 310, 320 may also help to lock the link 400 in a steer position and a stowed position respectively.

The link 400 is rotatable about the first axis 405 that is located on the rotational drive element 300 off-centre, as described above, and is also rotatable about a second pivot forming a second axis 415 that is mounted on the torsion controller 500. The torsion controller 500 is rotatable about a substantially centrally located torsion controller pivot pin that comprises a central axis 505 and the second axis 415 of the link 400 is located off-centre from the central axis 505 of the torsion controller. In some forms, the link 400 is substantially L-shaped, or arcuate, or the link may be a substantially arcuate L-shape. In the example shown in FIG. 1, the link 400 has a substantially arcuate L-shape. However, it should be appreciated that the link 400 may be of any suitable shape and dimensions to transfer rotational motion from the rotational drive element 300 to the torsion controller 500. The link 400 connects the rotational drive element 300 to the torsion controller 500 and allows the rotational drive element and the torsion controller to rotate independently about their respective axes of rotation 305, 505.

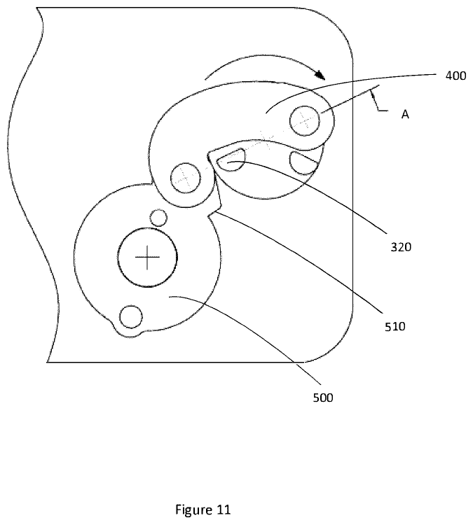

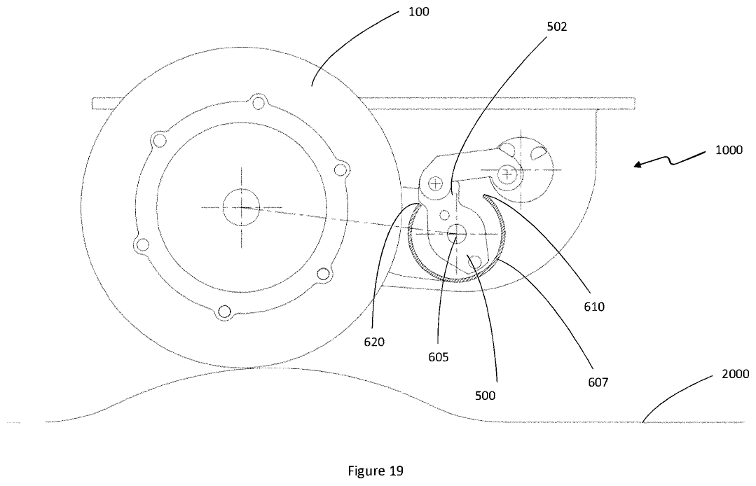

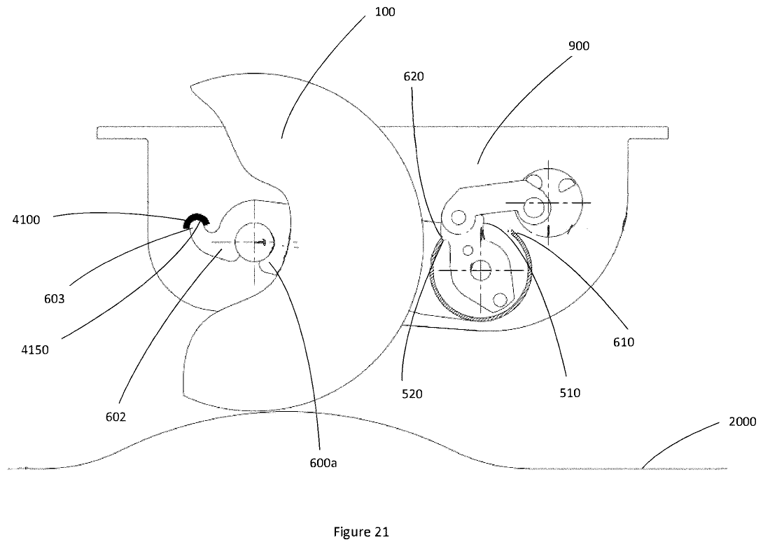

In some forms, the torsion controller 500 comprises a body portion 501 and a mounting portion 502 that projects radially from the torsion controller axis of rotation 505. The mounting portion 502 provides a mounting surface for the second pivot pin comprising a second rotational axis 415 for the link. In some forms, the body portion 501 of the torsion controller 500 comprises a substantially regularly shaped circular disc and the mounting portion 502 comprises a mounting tab that extends radially from the circumferential edge of the body portion, as shown best in FIGS. 11 to 14. In other forms, as shown in FIGS. 19 and 21, the torsion controller 500 may comprise a substantially oblong shape comprising a mounting tab 502 that projects from a side of the torsion controller. However, it is envisaged that the torsion controller 500 may be of any suitable shape.

The torsion controller 500 comprises a pair of first and second limit stops 510 and 520 that are configured to abut first and second swing stops 610, 620 of the swing arm 600 respectively. The abutment between the limit stops 510, 520 and the swing stops 610, 620 limits the extent of rotational movement of the swing arm when the wheel 100 is in the steer position. In effect, the arrangement between the limit stops 510, 520 and the swing stops 610, 620 limits the extent to which the wheel 100 can self-adjust by raising over a bump and lowering into a depression when in the steer position. In this way, the limit stops and swing stops set the parameters of the in-built suspension system within the retraction system of the invention.

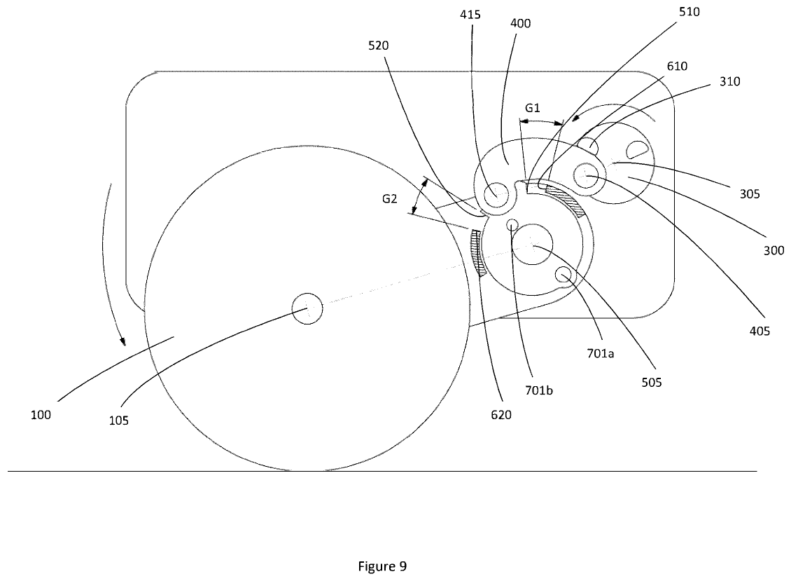

The first and second limit stops 510, 520 are mounted on the torsion controller 500. In some forms, the limit stops 510, 520 are positioned at the same radial distance from the rotational axis 505 of the controller 500 and are spaced from each other, as shown best in FIG. 9.

In some forms, as shown in FIG. 1, the torsion controller mounting portion 502 comprises a projecting mounting tab and opposing side edges of the mounting portion form the first and second limit stops 510, 520. However, in other forms, the first and second limit stops may project from any edge of the torsion controller or may project from a surface of the torsion controller, provided that the first and second limit stops are spaced apart and arranged to abut the first and second swing stops 610, 620 to define the limits of the suspension system when the wheel 100 is in the steer position and the swing arm 600 rotates relative to the torsion controller 500. The mounting portion/mounting tab 502 is typically located between the swing stops 610, 620 and is rotatable between the swing stops as the torsion controller 500 rotates, or the swing arm 600 (including the swing arm stops) rotates about the torsion controller 500.

The swing arm 600 connects the wheel 100 to the actuation system and comprises a first end 601 and a second, distal end 602. The first end of the swing able is rotatable about a third pivot comprising a rotational axis 605. The wheel 100 is attached to the swing arm 600 at or near the distal end 602 of the swing arm. In some forms, the swing arm 600 comprises a pair of first and second connecting members 600a, 600b that connect the actuation system to opposing sides of the wheel 100. The wheel 100 rotates about a wheel axle 105 connected to the swing arm 600. In some forms, the first and second connecting members 600a, 600b attach to the wheel axle 105, such that the wheel axle extends between the first and second connecting members 600a, 600b.

Swing stops 610, 620 may be provided on the swing arm, such as on the first connecting member 600a of the swing arm 600. The first connecting member 600a may be located proximate to the torsion controller 500. In some forms, as shown in FIGS. 7 and 9, the first connecting member 600a comprises a first surface on which the torsion controller 500 is rotationally mounted. In some forms, the torsion controller 500 and the swing arm 600 may share a common pivot pin about which the controller 500 and swing arm 600 rotate, the pivot pin therefore providing the torsion controller and the swing arm with a common rotational axis 505, 605. The swing stops 610, 620 may project from the first surface of the first connecting member 600a and the torsion controller 500 is positioned so that the limit stops 510, 520 are located between the swing stops 610, 620. Where the limit stops 510, 520, are provided on a projecting tab of the torsion controller, the tab 502 may be located between the swing stops 610, 620. In some forms, the swing stops 610, 620 may be located at the same radial distance from the axis 605 and are spaced from each other.

In some forms, each of the swing stops 610, 620 is located on an element that projects from the first surface of the first connecting member 600a of the swing arm 600. For example, each swing stop 610, 620 may be formed by an edge or sidewall of a projecting element. In the embodiment shown in FIGS. 7 and 9, the first connecting member 600a comprises a pair of projecting lugs that are spaced apart and located at the same radial distance from the axis 605. Each of the projecting lugs comprises a side edge or sidewall that faces towards the other of the projecting lugs and that forms an abutment surface. The limit stops 510, 520 of the torsion controller 500 are located within the gap/opening between the abutment surfaces of each of the projecting lugs. For example, the torsion controller 500 may comprise a mounting tab 502 on which the limit stops 510, 520 are provided and the mounting tab 502 may be at least partially located within the gap between the lugs. The abutment surface of each of the lugs is adapted to abut a respective limit stop 510, 520 of the torsion controller 500 when the swing arm 600 is raised or lowered. Thus, the projecting abutment surfaces of the lugs each form a swing stop 610, 620.

In another form, as shown in FIGS. 19 and 21, the first connecting member 600a may comprise a substantially circular projection 607 that is preferably concentric with the axis of rotation 605 of the swing arm 600. The substantially circular projection forms an incomplete circle and comprises an opening defined by distal ends of the projection such that distal ends of the projection are located at the same radial distance from the axis 605. The limit stops 510, 520 of the torsion controller 500 are located within the opening and between the distal ends of the projection. For example, the torsion controller 500 may comprise a mounting tab 502 on which the limit stops 510, 520 are provided and the mounting tab 502 may be at least partially located within the opening of the substantially circular projection. The distal ends of the substantially circular projection each comprise an edge or a sidewall that forms an abutment surface adapted to abut a respective one of the limit stops 510, 520 of the torsion controller 500 when the swing arm 600 is raised or lowered. Thus, the projecting abutment surfaces each form a swing stop 610, 620.

In other forms, the torsion controller may comprise a notched portion in its outer/circumferential edge and sides of the notched portion may form the limit stops. In such an arrangement, the swing stops of the swing arm may be located between the limit stops and may be adapted to abut the limit stops to define the parameters of the suspension system as the swing arm rotates relative to the torsion controller.

The swing arm 600 may further comprise a cross member 600c that extends between the first and second connecting members 600a, 600b. Each of the first and second connecting members 600a, 600b, comprises a proximal end that is connected to the auxiliary wheel 100, and a distal end. In some forms, the distal ends of the connecting members 600a, 600b are connected to the cross member 600c. In other forms, the cross member 600c may be located between the distal ends of the connecting members 600a, 600b, such as at a substantially central point along the length of the connecting members 600a, 600b. However, to provide the greatest leverage, it is preferred that the cross member 600c is located at or proximate to the distal ends of the connecting members 600a, 600b.

The swing arm 600 is adapted to rotate about the swing arm axis 605, which is distanced from the wheel 100 and is preferably located at or near the distal ends of the connecting members 600a, 600b. In some forms, the swing arm axis 605 is substantially centrally located within the cross member 600c. The axis of rotation 605 of the swing arm 600 is typically coaxial with the axis of rotation 505 of the torsion controller 500.

The retraction system of the invention comprises at least one torsion element 700 that has a major axis that lies substantially parallel to the wheel axle and to the axis of rotation of the swing arm 600. The torsion element 700 is tensioned and engages with the swing arm 600 to impart a downward biasing force on the swing arm 600, and therefore on the wheel 100, when the wheel is in the steer position. In this way, the torsion element 700 urges the wheel 100 to maintain contact with the ground surface 2000, even when the ground surface is uneven.

In preferred forms, the major axis of the torsion element 700 extends perpendicular to the plane of each connecting member 600a, 600b of the swing arm 600. In some forms, the torsion element 700 is supported by the cross member 600c of the swing arm 600. For example, the cross member 600c may comprise a torsion element housing 650 that extends between the first and second connecting members 600a, 600b of the swing arm and that comprises a hollow interior for housing at least a portion of, or substantially the entirety of, the torsion element 700 therein. A first end of the housing 650 may comprise an opening through which a first end of the torsion element 700 may extend to engage with the torsion controller 500 of the actuation system. The torsion element 700 is typically concentrically located around the swing arm axis of rotation 605.

In some forms, as shown in FIGS. 2, 5, 8, and 10, a first end of the at least one torsion element 700 (directly or indirectly) engages with the torsion controller 500 and a second end of the torsion element fixedly engages (directly or indirectly) with the swing arm 600. For example, where the torsion element is located within a torsion element housing 650 of the cross member 600c, a first end of the torsion element may be connected to the rotatable torsion controller 500, which may be at least partially located within or adjacent to a first end of the torsion element housing 650, and a second end of the torsion element may be fixedly connected at a second end of the housing 650. In such forms, rotation of the torsion controller 500 rotates the first end of the torsion element, while the second end of the torsion element remains fixed, thereby creating tension in the torsion element, which exerts a biasing pressure on the swing arm 600 and therefore on the wheel 100.

In some forms, the torsion element is inserted into one end of the housing 650 such that a first end of the torsion element 700 projects through a first end of the housing to engage with the torsion controller. A second end of the torsion element 700 may then be engaged with an end plate/torsion plate that is then fitted over a second end of the housing 650, rotated and then secured in place by one or more removable fasteners. By engaging the torsion element with the end plate, rotating the end plate, and then securing the end plate in position relative to the housing 650, the torsion element 700 can be held under tension within the housing.

In some forms, the torsion element 700 is pre-tensioned prior to, or during, assembly of the retraction system 1000. Pre-tensioning the torsion spring allows the wheel to be lowered to the floor and raised off the floor with minimal energy. When the torsion controller 500 is rotated towards the steer/drive position, the wheel initially contacts the floor before reaching the steer position. By using a pre-tensioned torsion element 700, it is possible to enhance the traction between the wheel and the floor. For example, by using a pre-tensioned torsion element 700, even once the wheel contacts the floor/ground surface, the torsion controller 500 continues to rotate to create a gap G1 between the first torsion controller limit stop 510 and the first swing arm stop 610, such that downward pressure is then applied to the wheel 100 to push the wheel against the floor. As the torsion controller 500 continues to rotate to the steer position, the torsion element 700 is further tensioned until the wheel reaches the steer position and is fully subjected to the tension of the torsion element 700. Conversely, rotation of the torsion controller 500 in the opposite direction (starting from a steer position) will decrease the tension in the torsion element 700 until the torsion controller limit stop 510 contacts the swing arm limit stop 610, and then causing the wheel to lift off the floor. Once the torsion controller limit stop 510 has contacted the swing arm stop 610, the torsion controller 500 only needs to support the weight of the wheel and swing arm, and no longer resists the pre-tensioned torsion element 700, making it easier to retract the wheel. Thus, when moving the wheel to the steer position, the torsion element 700 is placed under increasing tension as rotation of the torsion controller 500 in one direction (to cause downward movement of the wheel 100) will increase the tension in the torsion element 700, helping to hold the swing arm 600 in the downward/steer position and press the wheel against the floor 2000. Conversely, rotation of the torsion controller 500 in the opposite direction, toward the stowed position, will decrease the tension in the torsion element 700, making it easier to retract the wheel 100.

The torsion element 700 may be pre-tensioned by any suitable method and arrangement. In some forms, the at least one torsion element 700 may be pre-tensioned within the torsion element housing 650 prior to assembling the retraction system or during assembly of the retraction system.

For example, the torsion controller 500 may be at least partially located within a first end of the housing 650 or adjacent to an opening at the first end of the housing 650. The torsion controller 500 may be rotated until the first limit stop 510 contacts the first swing stop 610. A first end of the torsion element may be located in engagement with the torsion controller 500. A second end of the torsion element may be engaged with a rotatable tensioner 660 located at a second end of the housing 650, such as by being received within an aperture or recess of the tensioner 660, for example. In some forms, the tensioner 660 is located within the housing 650. In some forms, the second end of the housing may comprise a tensioning plate/member comprising an arcuate slot 635. In some forms, the tensioning plate/member may form an end cap to the housing 650. The arcuate slot 635 has a centre of curvature that corresponds with a central axis of the rotatable tensioner 660 and the torsion element 700. The tensioner 660 may comprise a second surface that faces toward the second end of the housing and comprises a tensioning feature 665 that substantially aligns with the slot 635 and that is engageable to rotate the tensioner 660 within the housing 650 by sliding the tensioning feature about the length of the arcuate slot 635.

In some forms, as shown in FIG. 5, the tensioning feature 665 comprises an aperture that is adapted to receive a prong of a tensioning tool, such that a user can insert the prong into the tensioning aperture to rotate the tensioner 660 within the housing 650. In other forms, the tensioning feature 665 may comprise a tensioning pin 665 that projects through the slot 635 from the second surface of the tensioner 660 and may be gripped by an operator and slid along the slot 635 to rotate the second end of the tensioner 660. In each form, the tensioner 660 is rotated within the housing 650 in a direction that rotates the torsion element 700 away from the wheel 100 (clockwise in FIG. 5) in order to place the torsion element under tension.

Once the torsion element is sufficiently tensioned, one or more fasteners 670 may secure the tensioner 660 in position relative to the housing 650 to prevent further rotation of the tensioner 660. In some forms, fasteners may be used to attach the tensioner 660 to a sidewall of the housing 650.

In another form, the housing 650 may comprise a central body and first and second ends at opposing ends of the body. An opening may be provided at the first end to allow the first end of the torsion element 700 to engage with the torsion controller, which is locked in position, as described above. The second end of the housing 650 comprises a tensioner that is rotatable relative to the housing body. In some forms, the tensioner may comprise a rotatable and/or removable, rotatable, and repositionable end cap of the housing. A second end of the torsion element 700 may be engaged with the rotatable tensioner of the housing 650, such as by projecting into a recess or opening of the tensioner or by being secured to the tensioner, for example. The tensioner/second end of the housing 650 may then be rotated, such as away from the wheel 100 (clockwise in FIG. 5), to tension the torsion element 700. Once the torsion element is sufficiently tensioned, one or more fasteners may be used to secure the second end to the body of the housing 650 to hold the torsion element 700 under tension.

Therefore, the retraction system 1000 may be configured to hold the torsion element 700 in a pre-tensioned state to bias the wheel toward the downward, steer position.

Optionally, as shown in FIG. 2, the retraction system 1000 comprises a pair of torsion elements: a first torsion element 700a, and a second torsion element 700b, each of which are supported within a housing 650, that preferably forms a cross member 600c of the swing arm 600. In the example shown, the cross member 600c and the torsion element housing 650 are provided between the distal ends of the connecting members 600a, 600b. The first torsion element 700a comprises a substantially hollow interior for receiving at least a portion of the second torsion element 700b coaxially therein. The torsion elements 700a, 700b may be concentrically located around the rotational axis 605 of the swing arm.

Each torsion element 700a, 700b may be pre-tensioned in the same ways described above. For example, a first end of each torsion element 700a, 700b may engage with the torsion controller 500, such as by projecting into a respective recess or opening formed in the torsion controller, as shown in FIG. 2. Also as shown in FIG. 2, the second end of each torsion element may engage with a respective engagement feature, such as a recess or opening, provided on a rotatable tensioner, which is then rotated away from the wheel and secured to the housing 650, as described above to hold the torsion elements 700a, 700b under tension. Alternatively, the second end of each torsion element may engage with a respective engagement feature, such as a recess or opening or a secured join/weld, provided on a rotatable end plate of the housing 650 that is rotated away from the wheel 100 and then secured to the body of the housing 650, as described above, to hold the torsion elements 700a, 700b under tension.

Preferably, each torsion element 700a, 700b comprises a spring and a first end of each spring engages with a receiving feature of the torsion controller 500 and a second end of each spring engages with a receiving feature of the swing arm 600. The receiving features may each comprise a recess or opening or a hooked arrangement, or any other suitable feature for engaging an end of a spring. In the example shown in FIG. 2, a first end of each torsion element spring 700a, 700b projects through a respective opening provided in the torsion controller 500 to form first and second spring drive dogs 701a, 701b respectively.

By providing two torsion elements/springs, as shown in FIG. 2, the retraction system of the invention allows for redundancy in order to provide a safety backup if one of the torsion elements/springs fails. In such a scenario, the remaining torsion element/spring can continue to apply a downward force on the wheel. However, it should be appreciated that the retraction system may otherwise operate with a single torsion element/spring, as shown in FIG. 6. Preferably, the torsion springs are steel torsion springs, but it is envisaged that a rubber torsion spring could be used instead.

As described above, in some forms, the torsion element engages with the torsion controller of an actuation system that also comprises a motor 200, a rotational drive element/crank 300, and a connecting link 400. However, in other forms, instead of including a rotational drive element and a link, the actuation system of the retraction system comprises a linear actuator that comprises a first end that is rotatably mounted to a fixed pivot on a chassis of the wheeled apparatus or to a housing of the retraction system, and a second end that is rotatably connected to the torsion controller via a rotational axis. This arrangement allows the linear actuator to rotate the torsion controller clockwise and anti-clockwise by extension and retraction of the linear actuator. The torsion element engages with the swing arm and the torsion controller to raise and lower the wheel, as described above. However, by providing a retraction system comprising an actuation system that comprises a rotational drive element/crank 300 and connecting link 400 (as described herein) rather than a linear actuator, the retraction system is more compact.

In yet another form, instead of including a crank and a link, the actuation system of the retraction system comprises a gear motor that is connected to the torsion controller to directly rotate the torsion controller in the clockwise and anti-clockwise directions in a 1:1 arrangement. The torsion element engages with the swing arm and the torsion controller to raise and lower the wheel, as described above. However, by providing a retraction system comprising an actuation system that comprises a rotational drive element/crank 300 and connecting link 400 (as described herein), less strain is placed on the motor to actuate the retraction system.

Furthermore, a retraction system that comprises a rotational drive element/crank 300 driven by a motor 200 and connected to the torsion controller 500 via a pivotable link 400 (as described herein), allows for the wheel 100 to be lowered quickly and for a gradual increase in torque to be applied to the swing arm 600, resulting in a gradual increase in downward pressure on the wheel 100. This form of retraction system is also relatively compact compared to that which comprises a linear actuator.

The retraction system 1000 of the invention may further comprise a user interface connected to a control system. In some forms, the control system may be a programmable control system. The control system comprises a data processor and is operably connected to the motor 200 and at least one sensor 800. The data processor is adapted to receive data from the at least one sensor 800 and use the data to determine the position of the wheel 100. The user interface is configured to electrically receive user inputs to select whether the wheel 100 should be in the raised, stowed position or the lowered, steer position. For example, where the wheel 100 is a powered drive wheel, the user input may be a DRIVE or STEER command that will cause the retraction system 1000 to lower the wheel 100 to the steer position and that will also cause a second motor to then rotate the wheel in the desired direction, such as forward or in reverse.

The at least one sensor 800 may be configured to sense whether the wheel 100 is in a stowed position or a steer position. In some forms, the at least one sensor may be located proximate to the rotational drive element 300, link 400, torsion controller 500, or swing arm 600 and may sense the position of the rotational drive element 300, link 400, torsion controller 500, or swing arm 600 and transmit that information to the data processor, which receives data from the at least one sensor 800 and uses the data to determine the position of the wheel 100. In another form, the at least one sensor may be mounted on the rotational axis 305 of the rotational drive element 300 or on the output axis of the motor.

The control system is programmed to operate the actuation system, by causing the motor 200 to rotate in a clockwise or an anti-clockwise direction or to stop rotation, depending on the latest user input and the position of the wheel 100 as determined by the data processor.

In some forms, the retraction system 1000 comprises two sensors to sense the position of the wheel 100, such as by sensing the position of a component of the system 1000 that moves simultaneously with the wheel as the wheel moves between positions. In some forms, the two sensors may comprise: an optical encoder sensor 810 and a limit switch, such as a toggle switch 820. The optical encoder sensor 810 measures the speed of rotation and the position of the rotational drive element 300, and the toggle switch identifies the direction of movement of the rotational drive element 300. The toggle switch is toggled in a first direction when the rotational drive element is rotated in the same direction and the swing arm raises the wheel to a stowed position and toggled in a second direction when the rotational drive element is rotated in the same direction and the swing arm lowers the wheel to a steer position. Data from the sensors allows the data processor of the controller to determine when the wheel 100 is in the stowed position and the steer position. The sensors 810, 820 are preferably arranged to sense the direction of movement, speed of movement, and the extent of movement of the wheel 100 based on the rotation of the rotational drive element 300, as driven by the motor 200. Of course, as the rotational drive element 300 rotates, the swing arm 600 is caused to rotate, so monitoring movement of the rotational drive element 300 allows for monitoring movement of the swing arm 600, and therefore also the wheel 100, to be monitored. As above, data from the sensors 810, 820 is transmitted to the processor of the control system to determine the position of the wheel 100 based on the information received from the sensors 810, 820.

As shown in FIGS. 3 to 6, the optical encoder sensor 810 comprises a rotatable encoder wheel 810a that is mounted on the same axis 305 as the rotational drive element 300, so that as the motor 200 rotates the rotational drive element in one direction, the encoder wheel is caused to rotate in the same direction. The encoder wheel 810a may be a typical encoder wheel comprising a toothed periphery with gaps between adjacent teeth. The optical encoder sensor 810 also comprises an optical sensor 810b that senses light passing through the gaps of the encoder wheel 801a to determine the speed and direction of rotation of the encoder wheel 810a and therefore of the rotational drive element 300.

A toggle switch 820 may be proximate to (or on) the encoder wheel 810a and is adapted to engage with a pair of position indicators 831, 832 that may be located on (or proximate to) the encoder wheel 810a and that are adapted to toggle the toggle switch between first and second directions depending on the direction of rotation of the rotational drive element 300 (and encoder 810) and therefore of the swing arm 600.

In some forms, as shown in FIGS. 3, 4 and 6, a pair of first and second position indicators 831, 832 may be mounted on the optical encoder wheel 810a in a spaced apart arrangement. Preferably, the position indicators 831, 832 are mounted on opposing sides of the encoder wheel 810a. The toggle switch 820 comprises a flexible tab which is caused by the first position indicator 831 to flex in a first direction when the encoder wheel 810a (and therefore the rotational drive element 300) rotates clockwise and the flexible tab of the toggle switch contacts the first position indicator 831, as shown in FIG. 3, and to flex in a second direction when the encoder wheel 810a (and therefore the rotational drive element 300) rotates anti-clockwise and the flexible tab of the toggle switch contacts the second position indicator 832, as shown in FIG. 4. In this way, the toggle switch 820 can sense the direction of rotation of the encoder wheel 810a and therefore of the rotational drive element 300 and the swing arm 600.

In one form, the position indicators 831, 832 comprise a pair of opposing projections that extend from a first surface of the encoder wheel 810a, and that are preferably located proximate the circumferential edge of the encoder wheel. In another form, as shown in FIGS. 3 and 4, the encoder wheel 810a comprises a substantially arcuate position member 830 comprising two terminal ends. One of the terminal ends forms the first position indicator 831 and the other of the terminal ends forms the second position indicator 832, each being adapted to contact the flexible tab of the toggle switch 820 as the toggle switch rotates past the respective indicator 831, 832.

Typically, the encoder wheel 810a is located between the motor output and the rotational drive element 300, but in other forms, the motor output may extend on opposing sides of the motor 200, so that the motor is at least partially located between the encoder wheel 810a and the rotational drive element 300.

Operation of one form of retraction system 1000 of the invention will now be described with reference to FIGS. 7 to 18.

FIG. 7 shows the wheel 100 in a retracted/stowed position. In this position, the wheel is raised off the ground surface and is locked in position. Preferably, when in the stowed position, the central axis of rotation of the wheel 100 (i.e., the axle 105) is vertically higher than the central axis of rotation 605 of the swing arm 600 to help raise the lower-most surface of the wheel sufficiently far above the ground surface to ensure that the wheel 100 does not extend beneath the chassis. This is because it is generally preferred to provide a clear space beneath the chassis and between the castors to allow for the chassis to be raised and lowered freely and to allow for other equipment to be slid beneath the chassis, if required.

As an example of how to reach the stowed position of FIGS. 7 and 8, a user may select a ‘STOW’, ‘RETRACT’, or ‘NEUTRAL’ position option from the user interface (or any other suitable option relating to placing the wheel in the stowed position), which causes the control system to actuate the motor 200. The motor rotates in a first direction, causing the rotational drive element 300 to rotate in the first direction. In the embodiment of FIG. 7, the first direction is a clockwise direction. Because the first rotational axis 405 of the link 400 is mounted on the rotational drive element 300, the first end portion of the link is moved in the general direction of rotation of the rotational drive element 300. As the link 400 rotates upwards, the link 400 is caused to pivot around its first rotational axis 405 and the second rotational axis 415 of the link is pulled generally toward the first rotational axis 405, thereby causing the torsion controller 500 to rotate in the same first/clockwise direction as the rotational drive element 300. Rotating the torsion controller 500 in the first direction, causes the first end of the engaged torsion element/spring(s) to rotate in the same direction, reducing the tension in the pre-tensioned torsion element. As the torsion controller 500 continues to rotate with the rotating rotational drive element 300, the first limit stop 510 of the torsion controller 500 contacts the first swing stop 610. Continued rotation of the rotational drive element 300 and torsion controller 500 in the first direction causes the first limit stop 510 to push against the first swing stop 610, causing the swing arm 600 to rotate about its rotational axis 605 in the first direction, and to thereby lift the wheel 100 off the ground surface 2000 to adopt the stowed position. At the same time, the upward pressure member 320 of the rotational drive element 300 contacts a lower surface of the link 400 to help hold the link 400 in position.

The control system continues to drive the motor 200 to rotate the rotational drive element 300 in the first direction until the processor determines that the wheel 100 is in the stowed position, based on data received from the sensor(s) 800. Once the wheel 100 is determined to be in the stowed position, the control system stops the motor 200.

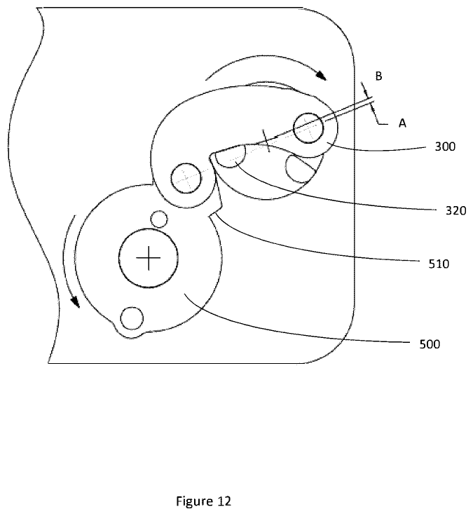

In the stowed position, the link 400 is over-centred and the upward pressure member 320 contacts a lower surface of the link 400 in the over-centred position, which creates a mechanical stop to lock the link 400 in position, thereby locking the torsion controller 500 against the swing arm 600 to maintain the wheel 100 in the raised, stowed position, as shown in FIGS. 7 and 8 and as demonstrated in FIGS. 11 and 12. For example, FIG. 11 shows the position of the link 400 just prior to being over-centred by rotation of the rotational drive element 300. Line A passes through the first and second rotational axes 405, 415 of the link 400 and also generally passes through the rotational axis 305 of the rotational drive element 300. In FIG. 12, the upward pressure member 320 of the rotational drive element 300 is contacting a lower surface of the over-centred link 400. The over-centred arrangement is illustrated by line A, which passes through the first and second rotational axes 405, 415 of the link but is distanced from line B, which generally passes through the rotational axis 305 of the rotational drive element 300.

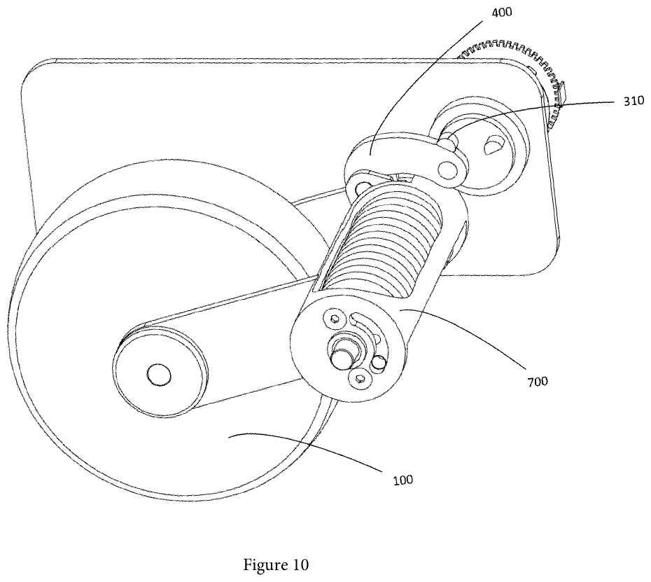

To reach the steer position, as shown in FIGS. 9 and 10, a user selects the ‘STEER’ or ‘DRIVE’ or ‘Lower’ option from the user interface (or any other suitable option relating to placing the wheel in the steer position), which causes the control system to actuate the motor 200. The motor rotates in a second direction (opposite to the first direction), causing the rotational drive element 300 to rotate in the second direction. In the embodiment of FIG. 9, the second direction is an anti-clockwise direction. As the rotational drive element 300 rotates in the second direction, the downward pressure member 310 of the rotational drive element rotates toward the link 400. Because the first rotational axis 405 of the link 400 is mounted on the rotational drive element 300, the link is pushed generally toward its second rotational axis 415 by rotation of the rotational drive element 300. Movement of the link 400 toward its second rotational axis 415, which is mounted on the torsion controller 500, causes the torsion controller 500 to rotate in the same second/anti-clockwise direction as the rotational drive element 300, and releases the contact between the first limit stop 510 of the torsion controller and the first swing stop 610 of the swing arm 600. Rotating the torsion controller 500 in the second direction, causes the first end of the engaged torsion element/spring(s) to rotate in the same direction, increasing the torsion of the pre-tensioned torsion element. As the torsion controller 500 rotates with the rotating rotational drive element 300, a gap G1 forms between the first limit stop 510 of the torsion controller and the first swing stop 610. A gap G2 is also retained between the second limit stop 520 of the torsion controller 500 and the second swing stop 620 of the swing arm 600. Therefore, neither of the limit stops 510, 520 of the torsion controller abut against either of the swing stops 610, 620, so the swing arm is free to rotate about its axis 605. The second rotational axis 415 of the link is now located approximately centrally between the swing stops 610, 620. Downward biasing pressure imparted on the swing arm 600 by the increased tension in the torsion element 700 urges the swing arm to rotate downwards so that the wheel 100 contacts the ground surface in the steer position.

The control system continues to drive the motor 200 to rotate the rotational drive element 300 in the second direction until the processor determines that the wheel 100 is in the steer position, based on data received from the sensor(s) 800. Once the wheel 100 is determined to be in the steer position, the control system stops the motor 200, which stops rotation of the actuation system, including the torsion controller 500. The torsion controller 500 is now in the neutral steer/mid-steer position. In this position, a gap is formed between each of the limit stops and an adjacent one of each of the swing stops to allow rotational movement of the swing arm 600 to provide a suspension system for the wheel 100. The length of the first gap G1 is preferably substantially equal to the length of the second gap G2. Preferably, the second axis 415 of the connecting link 400 is also located substantially centrally between the swing stops 610, 620 in the mid-steer position.

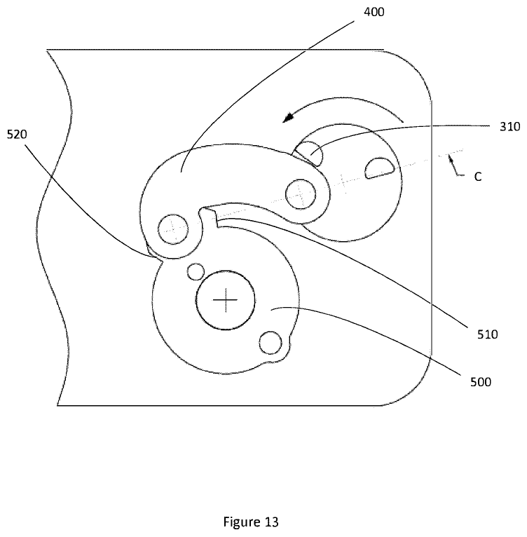

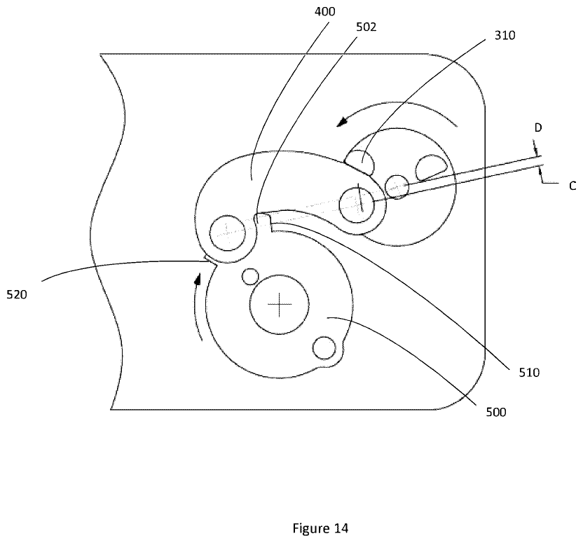

In the steer position, the link 400 is over-centred and the downward pressure member 310 contacts an upper surface of the link to act as a mechanical stop and help lock the link 400 and the torsion controller 500 in position, in order to maintain the wheel 100 in the lowered, steer position, as shown in FIGS. 9 and 10 and as demonstrated in FIGS. 13 and 14. For example, FIG. 13 shows the position of the link 400 just prior to being over-centered by rotation of the rotational drive element 300. Line C passes through the first and second rotational axes 405, 415 of the link 400 and also generally passes through the rotational axis 305 of the rotational drive element 300. In FIG. 14, the rotational drive element 300 has rotated further, causing over-centering of the link. The over-centred arrangement is illustrated by line C, which passes through the first and second rotational axes 405, 415 of the link 400 but is distanced from line D, which generally passes through the rotational axis 305 of the rotational drive element 300.

In the steer position, the wheel 100 can move between a neutral/mid-steer position, a lower-most steer position, and an upper-most steer position. In the mid-steer position, the gaps G1, G2 are maintained between the limit stops 510, 520 of the torsion controller 500 and the swing stops 610, 620. These gaps G1, G2 allow the swing arm 600 to rotate relative to the torsion controller 500 and to therefore allow the wheel 100 to be automatically raised and lowered, within limits, as the wheel 100 passes over an uneven ground surface. In effect, the arrangement provides a suspension system that allows the wheel to self-adjust its height relative to the chassis of the wheeled apparatus on which the retraction system may be located.

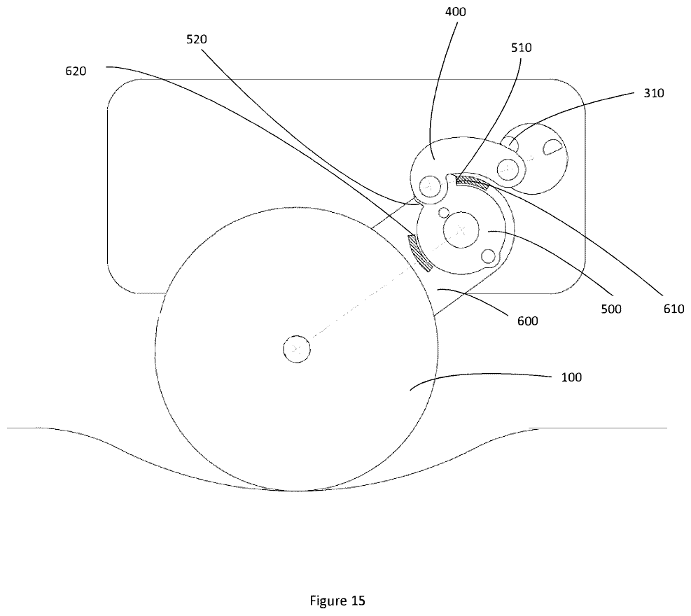

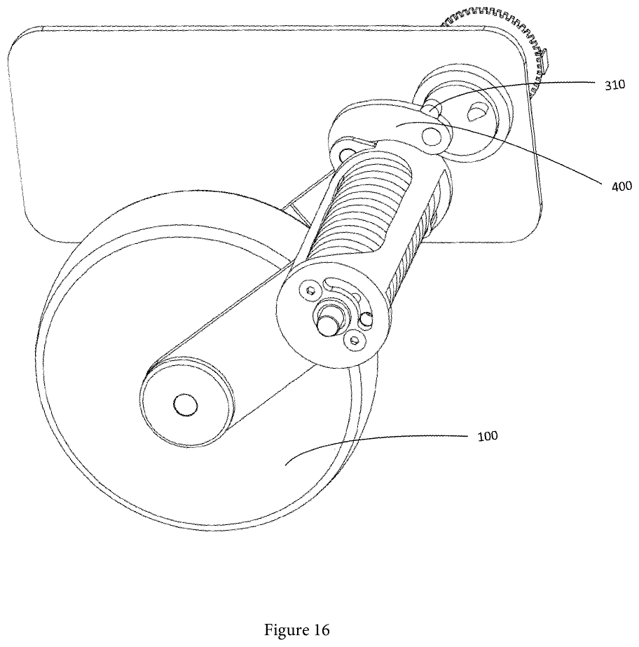

The wheel retraction system 1000 of the invention is configured to allow the wheel 100 to automatically lower when passing over a hollow/depression in the ground surface 2000, as shown in FIGS. 15 and 16. For example, the retraction system is configured to allow the wheel 100 to automatically lower into the hollow and to retain constant contact with the ground surface, as a result of gravity and the downward biasing force of the torsion element 700 on the swing arm 600. In the neutral mid-steer position, the retraction system allows the swing arm 600 to rotate downwardly and freely about its rotational axis 605 to allow the wheel 100 to drop into the hollow and remain in contact with the ground surface of the hollow. However, the retraction system limits the extent to which the wheel 100 can be lowered by limiting the extent to which the swing arm 600 can rotate downwardly. For example, as shown in FIG. 15, the swing arm is configured to rotate downwardly until the gap G1 is closed so that the first limit stop 510 contacts the first swing stop 610. When the first limit stop 510 abuts the first swing stop 610 to prevent further downward rotation of the swing arm 600, the wheel is in the lower-most steer position. Because the over-centred link 400 and downward pressure member 310 locks the torsion controller 500 in position, the torsion controller 500 is unable to rotate to accommodate further rotation of the swing arm 600. Therefore, further downward rotation of the swing arm is prevented by the abutment between the first limit stop 510 and the first swing stop 610. In this way, the torsion controller 500, via the first limit stop 510 and the first swing stop 610, controls and limits the extent to which the swing arm 600 is able to lower the wheel 100 when in the steer position.

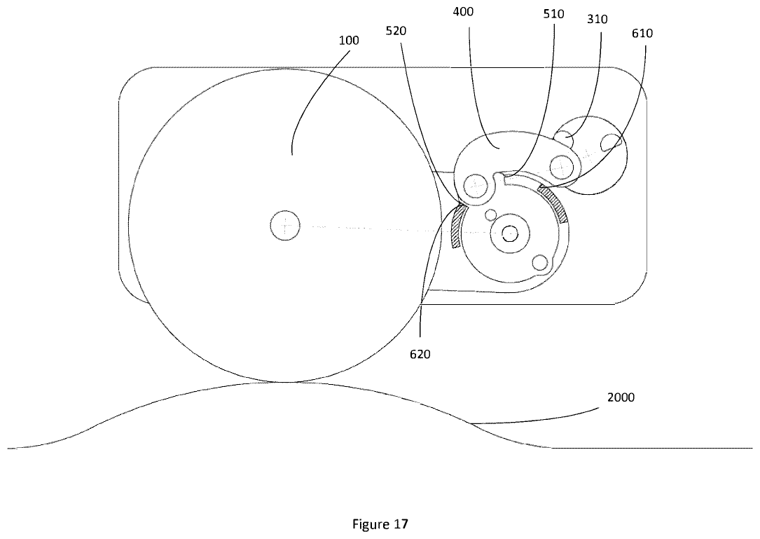

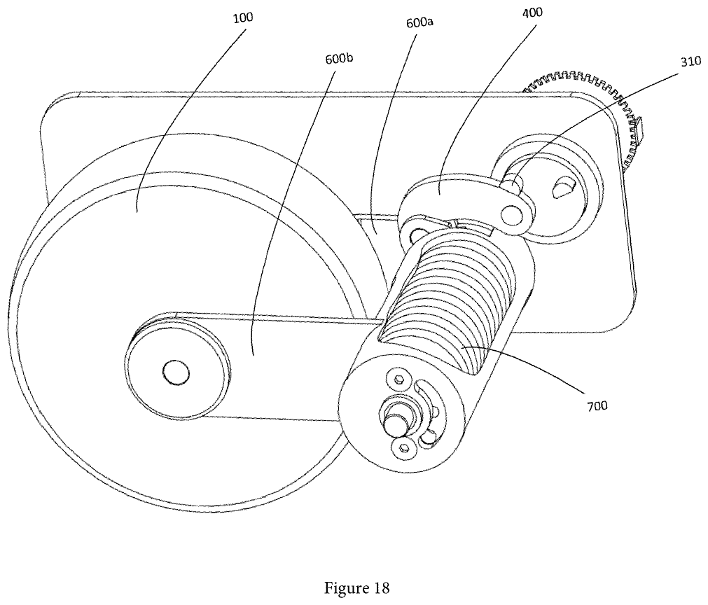

FIGS. 17 and 18 show one form of wheel retraction system 1000 of the invention in which the wheel 100 is passing over a raised area/bump in the ground surface 2000. The retraction system is configured to allow the wheel 100 to automatically raise over the bump by allowing the swing arm 600 to rotate upwardly and freely to accommodate the bump. The swing arm 600 is able to rotate upwardly until the gap G2 is closed so that the second limit stop 520 contacts the second swing stop 620. When the second limit stop 520 abuts the second swing stop 620 to prevent further upward rotation of the swing arm, the wheel is in the upper-most steer position. Because the over-centred link 400 and downward pressure member 310 are locking the torsion controller 500 in position, the torsion controller 500 is unable to rotate to accommodate further upward rotation of the swing arm 600. Therefore, upward rotation of the swing arm is prevented by the abutment between the second limit stop 520 and the second swing stop 620. In this way, the torsion controller 500, via the second limit stop 520, controls and limits the extent to which the swing arm 600, and therefore the wheel 100, is able to raise when in the steer position.

In some forms, the swing arm may comprise an engagement element configured to engage with an engagement feature to limit the extent of upward movement of the auxiliary wheel when in the steer position. This arrangement allows the suspension system to bottom out when the wheel passes over a large bump or transitions from a steep incline to a flat ground surface without causing damage to the retraction system. Without such an adequate independent movement limit, it may be possible for the auxiliary wheel to raise beyond its normal range of motion and to such an extent to cause damage to the retraction system because, in this situation, much of the weight of the wheeled apparatus may be borne by the retraction system.

The retraction system may be modified in any suitable way to limit the upward movement of the auxiliary wheel when in the steer position. For example, the swing arm may comprise an engagement element comprising an edge of the swing arm or comprising a protrusion, such as a nib or hook adapted to engage with a complementary engagement feature, which may be provided at any suitable approximate location, such as on the chassis, or on a housing of the retraction system, for example. The engagement element is typically located between a central region along the length of the swing arm and a distal end of the swing arm (opposite to its rotational axis). Preferably, the engagement element is located at or near the distal end of the swing arm. The engagement element of the swing arm is adapted to be located below the engagement feature.

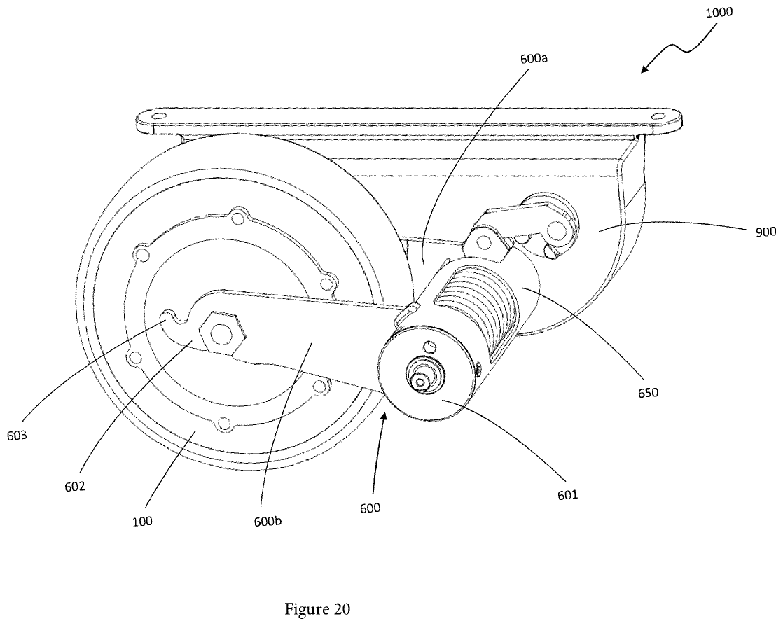

In preferred forms, as shown in FIGS. 20 and 21, the engagement element 603 is configured to engage with an engagement feature 4100 comprising an abutment surface, located above the engagement element of the swing arm, and provided on a housing 900 of the retraction system, for example, or on the chassis 4000 of the wheeled apparatus 5000, for example. In the embodiment shown in FIGS. 20 and 21, the distal end 602 of the swing arm 600 comprises an engagement element 603 that forms a hook-like member that engages with an engagement feature 4100 comprising a recess provided on the retraction system housing 900. The recess comprises a curved abutment surface 4150, defining an upper wall of the recess. The abutment surface 4150 is located above the distal end 602 of the swing arm 600 and abuts the engagement element 603 of the swing arm 600 as the distal end 602 of the swing arm pushes upwardly as a result of the attached auxiliary wheel 100 pushing upwardly, such that the hook-like member nests within the recess and presses against the abutment surface 4150 of the recess. The abutment surface 4150 therefore prevents further upward movement of the swing arm 600 and consequently of the auxiliary wheel 100. The abutment surface may be provided by any suitable arrangement such as one or more walls of a recess (as demonstrated in FIG. 21), one or more walls of an opening, or one or more projecting surfaces provided on the retraction system housing, for example, or on any other component of the retraction system or the wheeled apparatus that may engage with the swing arm at or near the distal end of the swing arm, or at least between a central point along the length of the swing arm and its distal end.

By abutting the engagement element of the swing arm against an engagement feature, or by otherwise engaging the engagement element with an engagement feature, and in which the engagement feature sits above the engagement element, the distal end of the swing arm and the attached auxiliary wheel is prevented from raising further relative to the chassis of the wheeled apparatus and a gap is provided between each of the limit stops 510,520 and the swing stops 610, 620, as shown in FIG. 19.

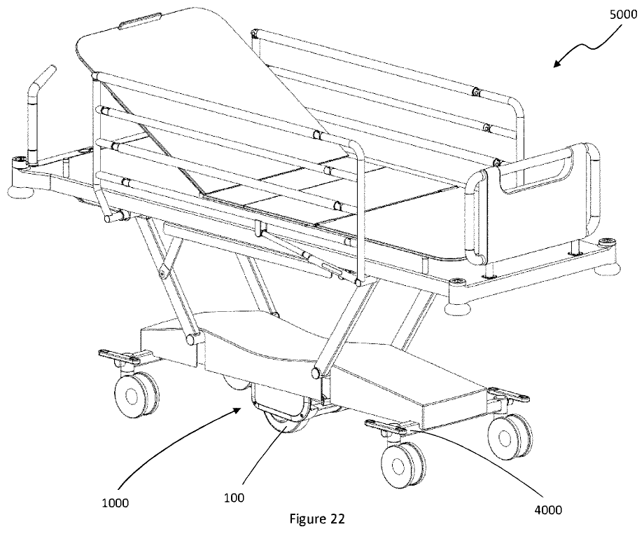

The wheel retraction system of the invention therefore provides a system by which the wheel is urged to maintain contact with the ground surface, when in the steer position, and is able to accommodate an uneven ground surface, to some extent. The wheel retraction system is also relatively compact and is mountable on a chassis 4000 of a wheeled apparatus 5000. In preferred forms, the retraction system of the invention may be at least partially located within a housing 900 mounted on the chassis of the wheeled apparatus on which the retraction system is used. For example, FIG. 22 shows a patient transport apparatus in the form of a stretcher that includes the wheeled retraction system of the invention mounted on a chassis of the apparatus. Thus, the invention also relates to a chassis of a wheeled apparatus that comprises a retraction system of the invention, and a wheeled apparatus that comprises a retraction system of the invention.

The various advantages of the wheel retraction system of the invention therefore make it well-suited for retracting a wheel of a wheeled apparatus, whether the wheel is an unpowered wheel or a powered drive wheel of a wheeled apparatus, such as hospital bed, a care bed, a stretcher, or a trolley, for example.

The invention may also be said broadly to consist in the parts, elements and features referred to or indicated in the specification of the application, individually or collectively, in any or all combinations of two or more of said parts, elements or features.

Although the invention has been described by way of example, it should be appreciated that variations and modifications may be made without departing from the scope of the invention as defined in the claims. Furthermore, where known equivalents exist to specific features, such equivalents are incorporated as if specifically referred in this specification.

1. A powered retraction system for a wheel rotatable about a wheel axle, the retraction system comprising an actuation system to raise the wheel to a stowed position and to lower the wheel to a steer position, wherein the actuation system comprises:
a motor;
a rotational drive element rotatable in a first direction and a second direction by the motor;
a rotatable torsion controller rotatable about a torsion controller axis;
a link rotatably connected to the rotational drive element and to the torsion controller to transfer rotational movement of the drive element to the torsion controller; and
a torsion element comprising opposing first and second ends and comprising a major axis extending substantially parallel to the wheel axle, the torsion element being held under tension;
and a swing arm rotatable about a swing arm axis by the torsion controller, wherein the swing arm is operably connected to the wheel axle, distanced from the swing arm axis, such that rotating the swing arm about its rotational axis raises or lowers the wheel,
wherein the first end of the torsion element is fixedly engaged with the rotatable torsion controller and the second end of the torsion element is fixedly engaged with the swing arm,
wherein rotation of the torsion controller in a first direction rotates the first end of the torsion element and provides torsion applied by the torsion element to the swing arm to urge the swing arm, and in turn the wheel, downwards against a surface; and
wherein rotation of the torsion controller in a second direction rotates the first end of the torsion element to decrease torsion applied by the torsion element to the swing arm and reduces downward pressure on the swing arm and therefore on the wheel to raise the wheel to the stowed position.

2. The powered retraction system of claim 1, wherein the torsion element is located within a torsion element housing that extends between first and second connecting members of the swing arm.

3. The powered retraction system of claim 2, wherein the torsion element housing comprises a first end through which the first end of the torsion element extends to engage with the torsion controller, and a second end with which the second end of the torsion element is engaged.

4. The powered retraction system of claim 1, wherein the torsion element is pretensioned before or during assembly of the retraction system, to urge the wheel toward downwards when the wheel is in the steer position.

5. The powered retraction system of claim 1, wherein the torsion element comprises a pair of co-axial torsion springs.

6. The powered retraction system of claim 1, wherein the link is rotatable about a first axis mounted off-centre on the rotational drive element and a second axis mounted off-centre on the torsion controller.

7. The retraction powered system of claim 6, wherein the rotational drive element comprises a downward pressure member adapted to contact an upper surface of the link when the rotational drive element is rotated in a first direction and the link is over-centred in a first position, and an upward pressure member adapted to contact a lower surface of the link when the rotational drive element is rotated in an opposing second direction and the link is over-centred in a second position.

8. The powered retraction system of claim 7, wherein the downward pressure member contacts the upper surface of the link when the wheel is in the steer position and the upward pressure member contacts the lower surface of the link when the wheel is in the stowed position.

9. The powered retraction system of claim 8, wherein the link is over-centered in relation to the rotational axis of the rotational drive element when the wheel is in the steer position and also when the wheel is in the stowed position, so that the link and the downward and upward pressure members lock the wheel in the respective steer position and stowed position.

10. The powered retraction system of claim 1, wherein the torsion controller comprises a pair of first and second limit stops and the swing arm comprises a pair of first and second swing stops adapted to abut the limit stops to limit rotational movement of the swing arm when the wheel is in the steer position.

11. The powered retraction system of claim 10, wherein the torsion controller and the swing arm are co-axially arranged and wherein the limit stops and the swing stops are radially spaced equidistant from the axis of rotation of the torsion controller and the swing arm.

12. The powered retraction system of claim 1, wherein the torsion controller comprises a radially extending mounting tab that provides a mounting surface for the link.

13. The powered retraction system of claim 12, wherein the mounting tab comprises substantially opposing side edges that form the first and second limit stops.

14. The powered retraction system of claim 13, wherein the mounting tab is located between the swing stops and is rotatable between the swing stops as the torsion controller rotates.

15. The powered retraction system of claim 10, wherein, in a mid-steer position, a gap is formed between each of the limit stops and an adjacent one of each of the swing stops to allow rotational movement of the swing arm to provide a suspension system for the wheel.

16. The powered retraction system of claim 15, wherein, in a lower-most steer position, the first limit stop abuts the first swing stop to prevent further downward rotation of the swing arm.

17. The powered retraction system of claim 16, wherein, in an upper-most steer position, the second limit stop abuts the second swing stop to prevent further upward rotation of the swing arm.

18. The powered retraction system of claim 1, and further comprising a control system connected to a user interface adapted to receive user inputs corresponding to a position selection for the wheel, and at least one sensor to sense a current position of the wheel, wherein the control system is operably connected to the motor and comprises a data processor adapted to receive data from the at least one sensor and process the data to determine the current position of the wheel, and wherein the control system operates the actuation system depending on the latest user input and the current position of the wheel as determined by the data processor.

19. (canceled)

20. (canceled)

21. The powered retraction system of claim 20, wherein the at least one sensor comprises an optical encoder sensor and a toggle switch adapted to sense the direction, speed, and extent of rotation of the wheel, in addition to the current position of the wheel.

22. A wheeled apparatus comprising the powered retraction system of claim 1.

23. (canceled)

24. The wheeled apparatus of claim 22, wherein the apparatus comprises a powered drive wheel and the retraction system is operably connected to the drive wheel to raise the wheel to a stowed position and to lower the wheel to a steer position.
